(19) United States
(12) Patent Application Publication
(10) Pub. No.: US 2011/0187829 A1
(43) Pub. Date: Aug. 4, 2011

(54) IMAGE CAPTURE APPARATUS, IMAGE CAPTURE METHOD AND COMPUTER READABLE MEDIUM

(75) Inventor: Mitsuyasu NAKAJIMA, Tokyo (JP)

(73) Assignee: CASIO COMPUTER CO., LTD., Tokyo (JP)

(21) Appl. No.: 13/014,058

(22) Filed: Jan. 26, 2011

(30) Foreign Application Priority Data
Feb. 1, 2010 (JP) P2010-020738

(51) Int. Cl. H04N 13/02; H04N 15/00

(52) U.S. Cl. 348/46; 348/E13.074

(57) ABSTRACT

There is provided an image capture apparatus. The apparatus includes: an image capture section configured to capture an image of a subject; a focal point distance detector configured to detect a focal point distance from a main point of the image capture section to a focal point of the image capture section on the subject; an image acquisition section configured to acquire first and second images of the subject; an image position detector configured to detect a first image position and a second image position, wherein the first image position represents a position of a certain point on the subject in the first image, and the second image position represents a position of the certain point on the subject in the second image; a 3D image generator configured to generate a 3D image of the subject based on a difference between the first image position and the second image position; a parallelism computation section configured to compute parallelism based on the first and second image positions and the focal point distance; and a display section configured to display the parallelism.

### CROSS-REFERENCE TO RELATED APPLICATION

This application claims priority from Japanese Patent Application No. 2010-020738, filed on Feb. 1, 2010, the entire contents of which are hereby incorporated by reference.

### BACKGROUND

1. Technical Field

The present disclosure relates to an image capture apparatus, an image capture method, and a computer readable-medium.

2. Related Art

A technique is described in Non-Patent Document 1 in which two cameras are fixed in placements such that the optical axes of the two cameras are parallel to each other and coordinate axes of the image coordinate systems are on the same straight line and facing in the same direction (namely the cameras are in parallel stereo alignment), a 3D image is then generated of a subject based on differences in that way a subject for image capture (referred to below simply as subject) appears in images captured by the two fixed cameras (namely, based on parallax) and on the distance between the cameras (namely, the base line length). A technique is also known of moving a single camera such that before and after movement the camera is in parallel stereo alignment, and generating a 3D image of a subject for image capture using two images captured with the camera before and after movement.
Non-patent Document 1: “Digital Image Processing” by Yoichi published by CG-ARTS Kyoukai, Nov. 2, 2009, page 251 to page 262.

A problem with the technique of Non-Patent Document 1 is that two cameras are required. A problem with the technique in which a 3D image is generated using two images captured with a single camera is that it is difficult to capture appropriate images for generating a 3D image, since it is difficult to achieve parallel stereo alignment before and after moving the camera.

### SUMMARY OF THE INVENTION

Exemplary embodiments of the present invention address the above disadvantages and other disadvantages not described above. However, the present invention is not required to overcome the disadvantages described above, and thus, an exemplary embodiment of the present invention may not overcome any of the disadvantages described above.

According to one or more aspects of the present invention, there is provided an image capture apparatus. The apparatus includes: an image capture section configured to capture an image of a subject; a focal point distance detector configured to detect a focal point distance from a main point of the image capture section to a focal point of the image capture section on the subject; an image acquisition section configured to acquire first and second images of the subject, the first and second images being captured by the image capture section whose focal point is on the subject; an image position detector configured to detect a first image position and a second image position, wherein the first image position represents a position of a certain point on the subject in the first image, and the second image position represents a position of the certain point on the subject in the second image; a 3D image generator configured to generate a 3D image of the subject based on a difference between the first image position and the second image position; a parallelism computation section configured to compute parallelism based on the first and second image positions and the focal point distance, the parallelism representing a degree to which an optical axis of the image capture section during capture of the first image and an optical axis of the image capture section during capture of the second image capture are parallel to each other; and a display section configured to display the parallelism.

According to one or more aspects of the present invention, there is provided a computer-readable medium storing a program for causing the computer to perform operations including: (a) capturing an image of a subject by an image capture section; (b) detecting a focal point distance from a main point of the image capture section to a focal point of the image capture section on the subject; (c) acquiring first and second images of the subject, the first and second images being captured by the image capture section whose focal point is on the subject; (d) detecting a first image position and a second image position, wherein the first image position represents a position of a certain point on the subject in the first image, and the second image position represents a position of the certain point on the subject in the second image; (e) generating a 3D image of the subject based on a difference between the first image position and the second image position; (f) computing parallelism based on the first and second image positions and the focal point distance, the parallelism representing a degree to which an optical axis of the image capture section during capture of the first image and an optical axis of the image capture section during capture of the second image capture are parallel to each other; and (g) displaying the parallelism.

According to one or more aspects of the present invention, there is provided an image capture method. The method includes: (a) capturing an image of a subject by an image capture section; (b) detecting a focal point distance from a main point of the image capture section to a focal point of the image capture section on the subject; (c) acquiring first and second images of the subject, the first and second images being captured by the image capture section whose focal point is on the subject; (d) detecting a first image position and a second image position, wherein the first image position represents a position of a certain point on the subject in the first image, and the second image position represents a position of the certain point on the subject in the second image; (e) generating a 3D image of the subject based on a difference between the first image position and the second image position; (f) computing parallelism based on the first and second image positions and the focal point distance, the parallelism representing a degree to which an optical axis of the image capture section during capture of the first image and an optical axis of the image capture section during capture of the second image capture are parallel to each other; and (g) displaying the parallelism.

Other aspects and advantages of the present invention will be apparent from the following description, the drawings and the claims.

### BRIEF DESCRIPTION OF THE DRAWINGS

Exemplary embodiments of the present invention will be described in detail based on the following figures, wherein:

FIG. 1A to 1D are diagrams showing an example of the external appearance of a digital camera according to an exemplary embodiment, wherein FIG. 1A is a front view, FIG. 1B is a back view, FIG. 1C is a view of the right side, and FIG. 1D is a top view;

FIG. 2 is a block diagram showing an example of a circuit configuration of a digital camera;

FIG. 3 is the front end of a flow showing an example of 3D image generation processing executed by a digital camera 100;

FIG. 4 is the back end of a flow chart showing an example of 3D image generation processing executed by the digital camera 100;

FIG. 5A is a function block diagram showing an example of a configuration of the digital camera 100;

FIG. 5B is a functional block diagram showing an example of a configuration of a parallelism evaluation section 150;

FIG. 6A is a flow chart showing an example of parallelism computation processing executed by the parallelism evaluation section 150;

FIG. 6B is a flow chart showing an example of actual movement amount computation processing executed by an actual movement amount computation section 162;

FIG. 6C is a flow chart showing an example of 3D modeling processing executed by a 3D image generator 170;

FIG. 7 is a diagram showing an example of a perspective projection model of an image capture section during image capture of a first image and during image capture of a second image;

FIG. 8A is a diagram showing a display example of parallelism performed by a display; and

FIG. 8B is a diagram showing a display example of required movement direction performed by a display.

### DETAILED DESCRIPTION OF EXEMPLARY EMBODIMENTS

Hereinafter, exemplary embodiments of the present invention will be now described with reference to the drawings. It should be noted that the scope of the invention is not limited to the illustrated example.

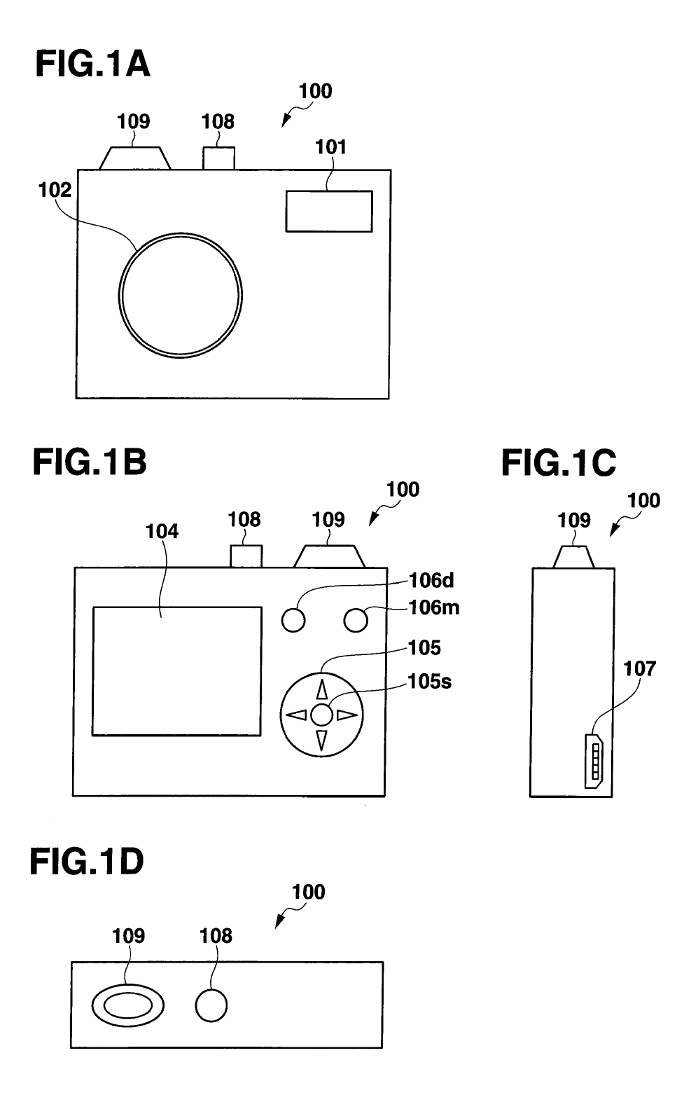

A digital camera 100 according to an exemplary embodiment is, as shown in FIG. 1A, modeled on a portable “compact camera”, carried by a user to change the image capture position. The digital camera 100 generates a 3D image representing a subject by employing 2 images captured of the subject before and alter changing the image capture position (namely before and after moving the digital camera 100). The digital camera 100 displays an indicator expressing whether the placements of the digital camera 100 before and after movement are out of alignment by any degree from parallel stereo alignment.

The digital camera 100, as shown in FIG. 1A, includes a flash light window 101 and an imaging optical system (image capture lens) 102 on the front face.

As shown in FIG. 1B, the digital camera 100 includes, on the back face, a display 104 that is a liquid crystal monitor screen, a cursor key 105, a setting key 105s, a menu key 106m, and a 3D (dimension) modeling key 106d.

The display 104 displays captured images, and a 3D image generated based on the captured images and parallelism computed from the captured images. The cursor key 105 inputs a signal for selecting from a menu displayed on the display 104 when the menu key 106m is depressed. The setting key 105s inputs a signal confirming the selected menu item. The 3D modeling key 106d operates by toggling, and inputs a signal each time it is depressed, to switch between two modes, a normal image capture mode for performing normal image capture, and a 3D modeling mode for generating a 3D image.

The digital camera 100, as shown in FIG. 1C, includes a Universal Serial Bus (USB) terminal connector 107 on the right hand side face, and, as shown in FIG. 1D, includes a power button 108 and a shutter button 109 on the top face.

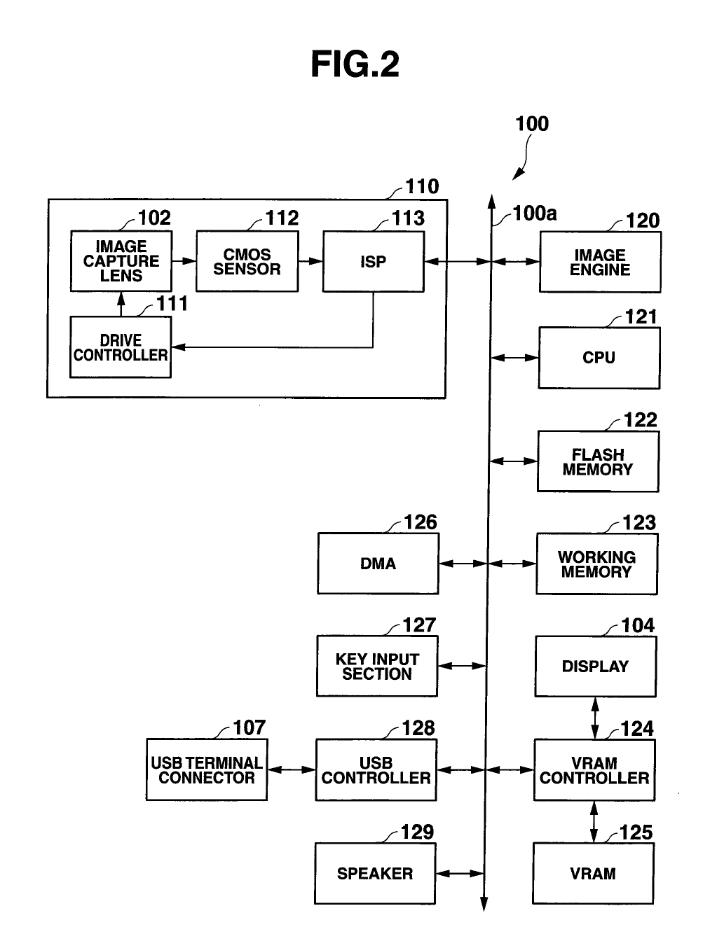

A circuit configuration of the digital camera 100 will be described hereinafter. The digital camera 100, as shown in FIG. 2, includes: an image capture section 110, an image engine 120, a Central Processor Unit (CPU) 121, a flash memory 122, a working memory 123, a Video Random Access Memory (VRAM) controller 124, VRAM 125, a Direct Memory Access (DMA) 126, a key input section 127, a USB controller 128 and a speaker 129, connected together by a bus 100a.

The image capture section 110 is a Complementary Metal Oxide Semiconductor (CMOS) camera module, captures an image of a subject, and outputs image data expressing the image captured subject. The image capture section 110 includes an imaging optical system (image capture lens) 102, an (optical system) drive controller 111, a CMOS sensor 112 and an Image Signal Processor (ISP) 113.

The imaging optical system (image capture lens) 102 focuses an optical image of a photographic subject (subject) onto an image capture face of the CMOS sensor 112. The drive controller 111 includes a zoom motor for adjusting the optical axis of the imaging optical system 102, a focusing motor for aligning the focal point of the image capture lens 102, an aperture controller for adjusting the aperture of the image capture lens 102, and a shutter controller for controlling the shutter speed.

The CMOS sensor 112 performs photoelectric conversion on light from the image capture lens 102, then Analog/Digital (A/D) converts the electrical signal obtained by photoelectric conversion and outputs the converted digital data.

The ISP 113 performs color adjustment on the digital data output from the CMOS sensor 112 and changes the data format, The ISP 113 then converts the digital data into a luminance signal Y and chromatic difference signals Cb and Cr.

Explanation regarding the image engine 120 follows that of the working memory 123. According to operation of the key input section 127, the CPU 121 reads out the image capture program and menu data corresponding to the operation from the flash memory 122, and controls each of the sections configuring the digital camera 100 by executing the program on read out data.

The working memory 123 is configured by DRAM, and the YCbCr data output by the image capture section 110 is transferred to the working memory 123 by the DMA 126 and the working memory 123 stores the transmitted data.

The image engine 120 is configured by a Digital Signal Processor (DSP), and after converting the YCbCr data stored in the working memory 123 into RUB format data, the image engine 120 transfers the converted data to the VRAM 125 via the VRAM controller 124.

The VRAM controller 124 controls display on the display 104 by outputting a RUB format signal to the display 104 after reading out ROB format data from the VRAM 125.

Under control from the CPU 121, the DMA 126 substitutes for the CPU 121 to transfer the output (YCbCr data) from the image capture section 110 to the working memory 123.

When the key input section 127 has been input by signals corresponding to operation of the cursor key 105, the setting key 105s, the menu key 106m, and the 3D modeling key 106d of FIG. 1B, the key input section 127 communicates the input signals to the CPU 121.

The USB controller 128 is connected to the USB terminal connector 107 and controls USB communication with a computer that is USB connected through the USB terminal connector 107, so as to output image files representing captured images or generated 3D image to the connected computer.

Under control from the CPU 121, the speaker 129 outputs a specific alarm tone.

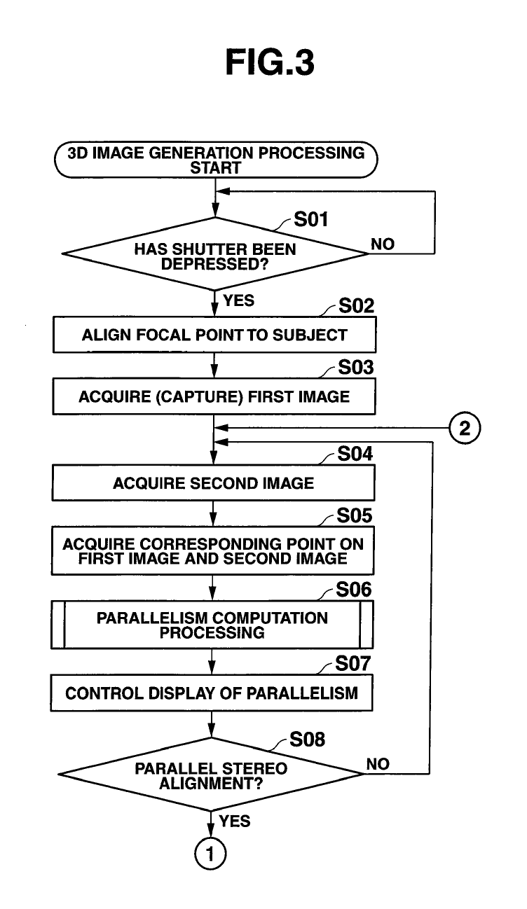

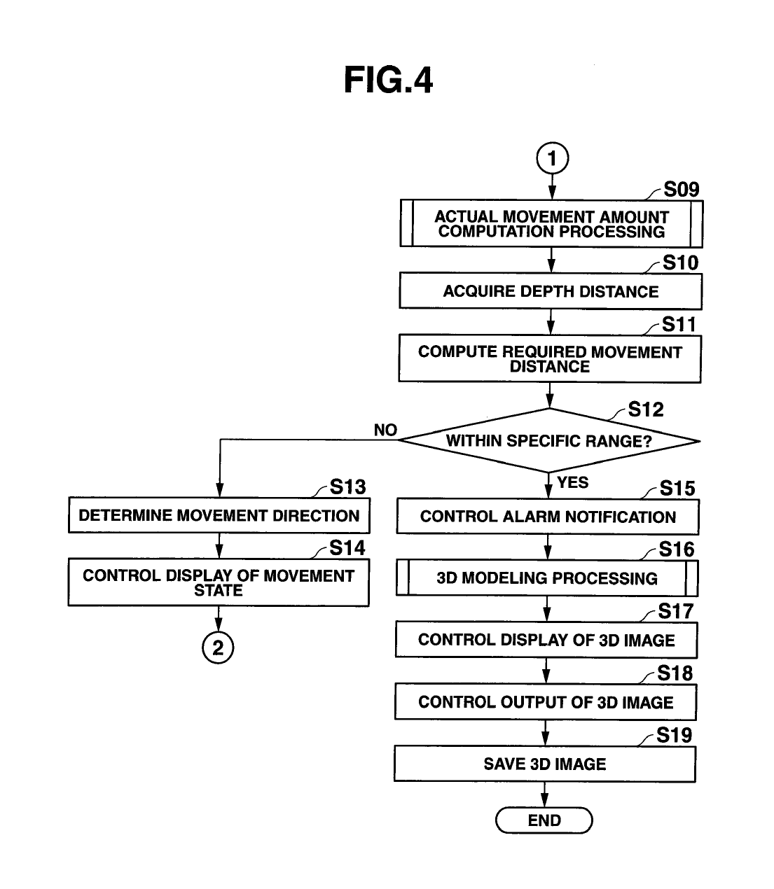

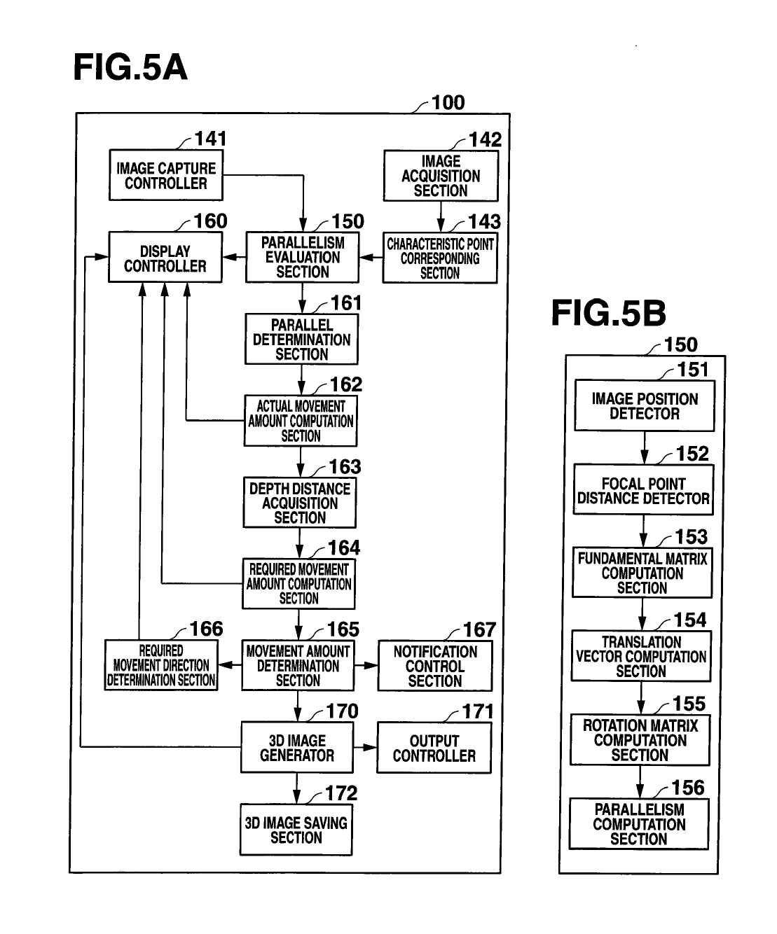

The 3D image generation processing in which the digital camera 100 generates 3D images using the hardware shown in FIG. 2 will be described hereinafter. The CPU 121 of FIG. 2 executes 3D image generation processing as shown in FIG. 3 and FIG. 4, and accordingly functions, as shown in FIG. 5A, as an image capture controller 141, an image acquisition section 142, a characteristic point corresponding section 143, a parallelism evaluation section 150, a display controller 160, a parallel determination section 161, an actual movement amount computation section 162, a depth distance acquisition section 163, a required movement amount computation section 164, a movement amount determination section 165, a required movement direction determination section 166, a notification control section 167, a 3D image generator 170, an output controller 171, and a 3D image saving section 172.

When a user has selected the 3D modeling mode by operation of the 3D modeling key 106d of FIG. 1B, the CPU 121 detects such selection and starts 3D image generation processing. When 3D image generation processing has been started, the image capture controller 141 of FIG. 5A determines whether or not the shutter button 109 has been depressed by a user (step S01). When the user has depressed the shutter button 109, the image capture controller 141 determines that the shutter button 109 has been depressed (Step S01: Yes) and aligns the focal point of the image capture section 110 to the subject for image capture. Specifically, if the subject is a person, the image capture section 110 performs face detection processing and controls the focal point of the image capture section 110 by driving the drive controller 111 of FIG. 2 so as to align with the position of the detected face (step S02). A standby state is adopted until the shutter button 109 is depressed when determination has been made that the shutter button 109 has not been depressed (step S01: No).

Next, the image acquisition section 142 acquires data from the image capture section 110 expressing the image captured of the subject (referred to below as the first image), and stores the acquired data in the working memory 123 of FIG. 2 (step S03). The digital camera 100 is then moved by the user to an image capture position that is different from the image capture position where the first image was captured. Next the image acquisition section 142, similarly to in step S03, acquires data expressing an image captured of the subject (referred to below as the second image), and stores the data in the working memory 123 (step S04).

The characteristic point corresponding section 143 of FIG. 5A next acquires corresponded points (a corresponding point) of a point on the first image and a point on the second image that express the same point on a subject (step S05). Specifically, the characteristic point corresponding section 143 employs a Harris corner detection method on the first image and the second image, thereby acquiring a characteristic point characterizing the first image (referred to below as the first characteristic point) and a characteristic point characterizing the second image (referred to below as the second characteristic point). Template matching is then performed between the first characteristic point and the second characteristic point on an image region (a characteristic point vicinity image) up to a specific distance from the characteristic point, and if the degree of matching computed by template matching is a specific threshold value or higher, the first characteristic point and the second characteristic point which give the highest value are corresponded with each other and these characteristic points are taken as the corresponding point.

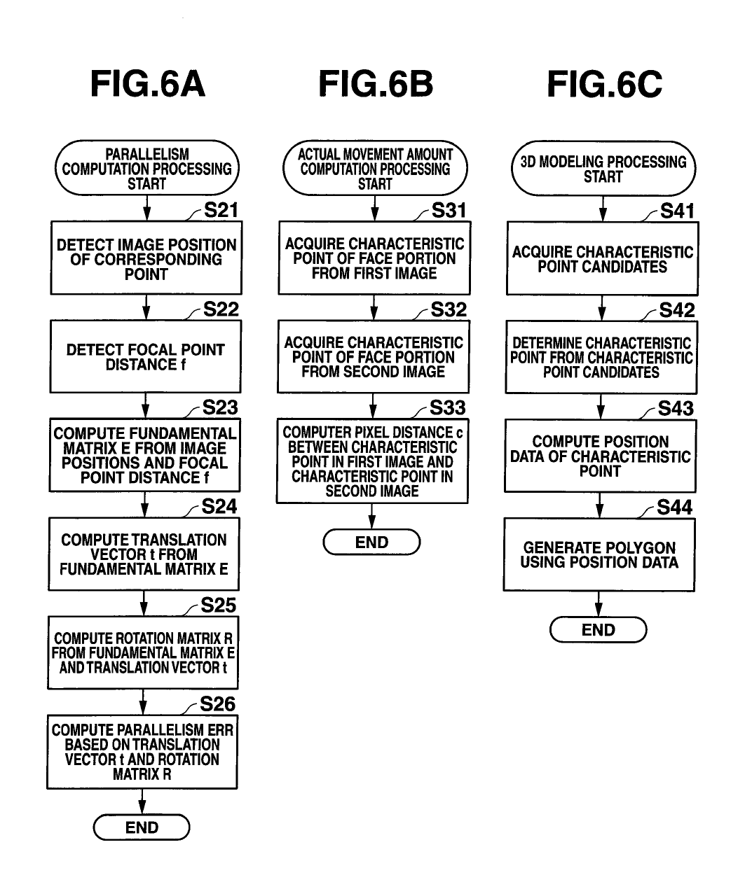

The parallelism evaluation section 150 then executes parallelism computation processing for computing the parallelism (step S06). By executing the parallelism computation processing as shown in FIG. 6A, the parallelism evaluation section 150 functions as an image position detector 151, a focal point distance detector 152, a fundamental matrix computation section 153, a translation vector computation section 154, a rotation matrix computation section 155, and a parallelism computation section 156.

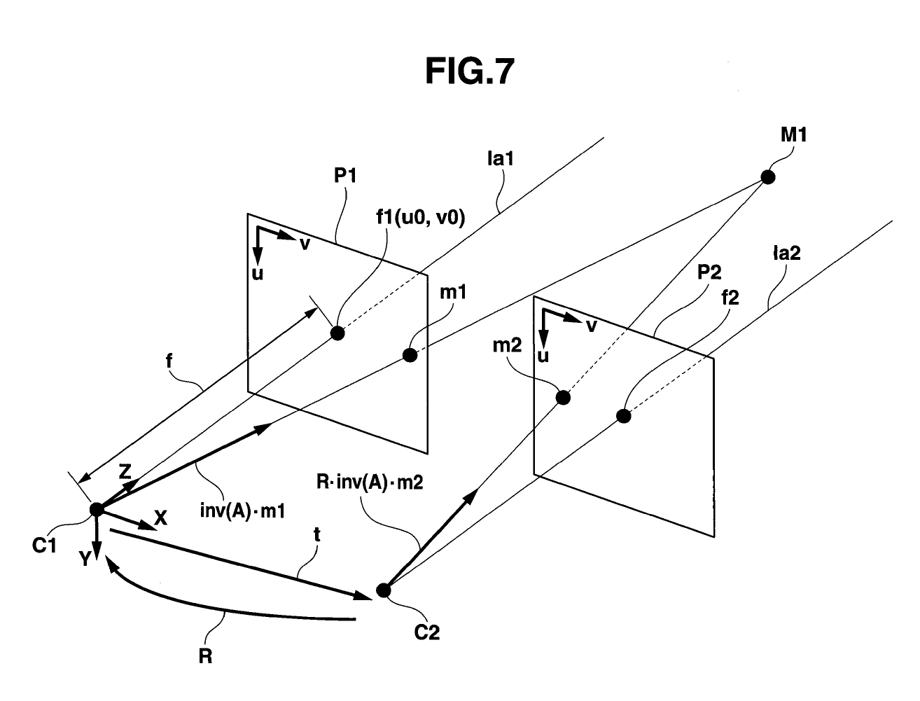

When parallelism computation processing has been executed at step S06, the image position detector 151 of FIG. 5B detects the coordinate values of a vector m1, as shown in FIG. 7, projected onto an image coordinate system P1 of the first image (referred to below simply as the first image position) of a corresponding point M1 on the subject and the coordinate values of a vector m2 of the corresponding point M1 projected onto an image coordinate system P2 of the second image (referred to below simply as the second image position) (step S21). FIG. 7 shows a perspective projection model before movement of the image capture section 110 (during first image capture) and after movement (during second image capture).

The image coordinate system P1 has as its origin the top left corner of the first image projected onto the projection plane of the image capture section 110, and has coordinate axes u and v in the vertical direction (vertical scanning direction) and the horizontal direction (horizontal scanning direction), respectively, that meet at the origin. The image coordinate system P2, similarly to the image coordinate system P1, has its origin at the top left corner.

After step S21 of FIG. 6A has been executed, the focal point distance detector 152 of FIG. 5B detects the focal point distance f between a main point C1 of the digital camera 100 during first image capture and a focal point f1 (step S22). The focal point f1 is expressed by the coordinates (u0, v0) where the optical axis la1 intersects the image coordinate system P1. Detection of the focal point distance is performed, for example, by utilizing the relationship been pre-measured signals applied to the lens driving section and the focal point distance f realized when these signals are applied to the lens driving section.

The fundamental matrix computation section 153 then uses the image positions of the corresponding point (namely the first image position and the second image position) and the focal point distance to compute a fundamental matrix E, as given by Equation (1) below (step S23). Whether or not the placements of the digital camera 100 when capturing the first image and when capturing the second image are in parallel stereo alignment can be determined by utilizing a translation vector t from the main point C1 of the image capture section 110 when capturing the first image towards the main point C2 of the image capture section 110 when capturing the second image, and a rotation matrix R expressing the rotation direction from the main point C2 towards the main point C1.

Fundamental matrix E=t×R (1)

where t represents the translation vector; R represents the rotation matrix; and “×” represents the outer product.

The inverse matrix of the matrix A, as represented in Formula (1-2) below, converts the image coordinate system P1 that depends on camera internal data (camera parameters) into a camera coordinate system with XYZ coordinate axes of FIG. 7 that is independent of camera parameters (namely, into a normalized camera coordinate system). Camera parameters include the focal point distance f determined in the image capture section 110 and the position of the intersection point (u0, v0) between the optical axis la1 and the image coordinate system P1. The camera parameters are predetermined prior to image capture. The X coordinate direction is aligned with the u coordinate direction, the Y coordinate direction is aligned with the v coordinate direction, the Z coordinate direction is aligned with the optical axis la1, and the origin in XYZ space is the main point C1. The aspect ratio of the CMOS sensor 112 of FIG. 2 is 1, and matrix A does not take into account parameters relating to scale.

$$A = ( \begin{matrix}f & 0 & u 0 \\ 0 & f & v 0 \\ 0 & 0 & 1\end{matrix} ) \qquad ( 1 \text{-} 2 )$$

The origin C1 of the normalized camera coordinate system is set as the origin of a world coordinate system, the directions of coordinate axes XwYwZw of the world coordinate system are set to the same respective directions as the coordinate axes XYZ of the normalized camera coordinate system, and the normalized camera coordinate of point m1 in world coordinates is given as inv(A)·m1, wherein: “inv” is used to represent the inverse matrix; and “·” is used to represent the inner product. Since point M1 has the image coordinate m2 when projected onto the second coordinates, the normalized coordinates of m2 in the world coordinate system is represented using the rotation matrix R as R·inv(A)·m2.

As shown in FIG. 7, since the translation vector t, the above inv(A)·m1 and R·inv(A)·m2 all fall in the same plane, the scalar triple product is the value “0”, and the following Equation (2), and the transformations of Equation (2) shown in Equation (3) to Equation (5), are satisfied.

trans(inv(A)·m1)·(t×(R·inv(A)·m2))=0 (2)

where “trans” represents the transformation matrix.

trans(m1)·trans(inv(A))·t×R·inv(A)·m2=0 (3)

trans(m1)·trans(inv(A))·E·inv(A)·m2=0 (4)

because fundamental matrix E=t×R (see Equation (1))

trans(m1)·F·m2=0 (5)

where the essential matrix F=trans(inv(A))·E·inv(A)

The essential matrix F is a 3 by 3 matrix, and since the matrix A does not take into consideration parameters relating to scale, the fundamental matrix computation section 153 of FIG. 5B computes the essential matrix F and the fundamental matrix E using 8 or more individual corresponding points (namely pairs of m1 and m2) and the above Equation (5).

After step S23 of FIG. 6A has been executed, the translation vector computation section 154 of FIG. 5B computes the translation vector t from the fundamental matrix E (step S25). Specifically, the translation vector computation section 154 computes a unique vector for the minimum unique values of the matrix “trans(E)·E”.

In the above Equation (1), since the fundamental matrix E is defined as =t×R, the inner product of fundamental matrix E and translation vector t is the value “0” due to satisfying Equation (6). Satisfying Equation (6) means that the translation vector t is a unique vector of the minimum unique values of matrix “trans(E)·E”.

trans(E)·t=0 (6)

The translation vector t has undefined scale and sign, however, the sign of the translation vector t can be derived by imposing the limitation that the subject must be in front of the camera.

After step S24 of FIG. 6A has been executed, the rotation matrix computation section 155 of FIG. 5B computes the rotation matrix R using the fundamental matrix E and the translation vector t (step S25). Specifically, due to the definition that fundamental matrix E=t×R in the above Equation (4), the rotation matrix computation section 155 employs Equation (7) below, and computes the rotation matrix R using a least-squares approach to give the minimum difference between the external product of the rotation matrix R being computed and the already computed translation vector t, and the already computed fundamental matrix E.

Σ(t×R−E)²→min (7)

where (t×R−E)² represents the square of the matrix; represents the sum of all the elements in the matrix; and “→” min represents minimization of the value of the left hand term.

The rotation matrix computation section 155, in order to solve the above Equation (7), employs the previously computed translation vector t and the fundamental matrix E to compute −t×E, and, as in Equation (8) below, applies singular value decomposition to −t×E, and computes a unitary matrix U, a diagonal matrix of singular values S, and an adjugate matrix V.

U·S·V=svd(−t×E) (8)

where “svd” represents singular value decomposition of the matrix −t×E inside the brackets.

Next, the rotation matrix computation section 155 computes the rotation matrix R using the computed unitary matrix U and the adjugate matrix V in Equation (9) below.

R=U·diag(1,1,det(U·V))·V (9)

where “det” represents the determinant; and diag represents a diagonal matrix.

After step S25 of FIG. 6A has been executed, the parallelism computation section 156 of FIG. 5B utilizes the translation vector t and the rotation matrix R in Equation (10) below to compute parallelism ERR (step S26). Execution of the parallelism computation processing is then ended.

ERR=α·R_ERR+k·T_ERR (10)

where α and k represent specific values of adjustment coefficients; R_ERR represents the error in the rotation system; and T_ERR represents the error in the movement direction.

The error in the rotation system R_ERR is an indicator representing how much rotation is required to superimpose the camera coordinate system during second image capture (the second camera coordinate system) on the camera coordinate system during first image capture (first camera coordinate system). When the rotation matrix R is the unit matrix, since the second camera coordinate system can be superimposed on the first camera coordinate system without rotation, the optical axis la1 during first image capture and the optical axis la2 during second image capture are parallel to each other. Therefore, the error in the rotation system R_ERR is computed by the sum of squares of difference in each component of the computation derived rotation matrix R and the unit vector.

The error in the movement direction T_ERR is the movement direction from the main point C1 during first image capture to the main point C2 during second image capture (namely the translation vector t), and is an evaluation indicator for evaluating the degree of difference to the X axis direction of the first camera coordinate system. When there is no Y component and no Z component in the translation vector t, since the X axis of the camera coordinate system during first image capture and the X axis of the camera coordinate system during second image capture are on the same straight line and in the same direction, the error in the movement direction T_ERR is computed from the sum of squares of the Y component and the Z component of the translation vector t.

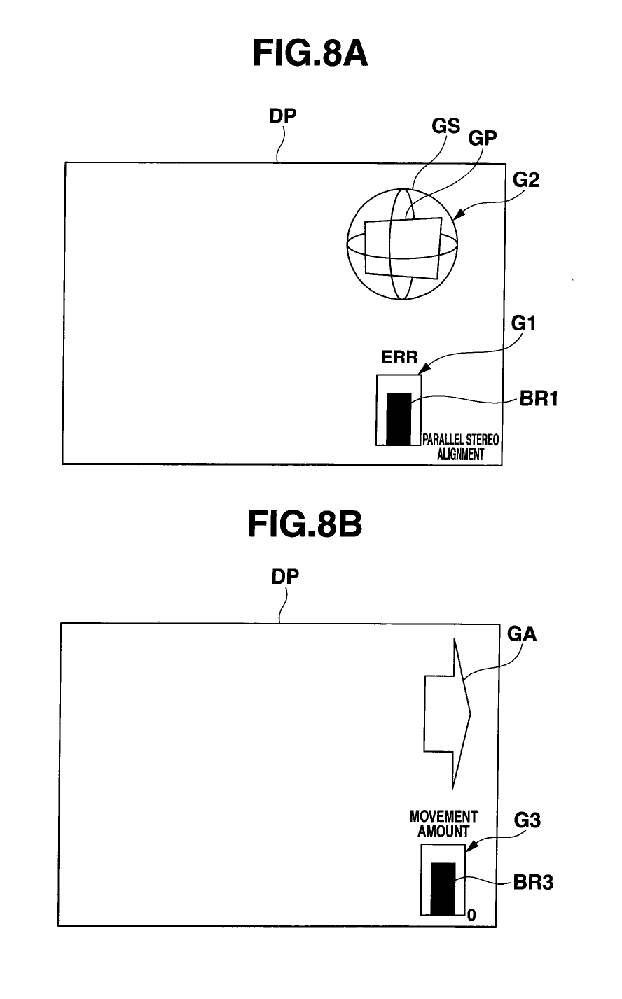

After step S06 of FIG. 3 has been executed, the display controller 160 of FIG. 5A controls the display 104 such that a bar graph G1, as shown in FIG. 8A, representing the value of parallelism ERR with a bar BR1, and a graph G2 representing the values of rotation matrix R and translation vector t are displayed (step S07). According to such a configuration, not only does this enable display of whether or not the placements of the digital camera 100 before and after movement are in parallel stereo alignment, it also enables display of by how much placement is away from parallel stereo alignment. Accordingly, since the camera placements of the digital camera 100 before and after movement can readily be made to be in parallel stereo alignment, image capture can readily be made of images appropriate for generation of a 3D image.

In the bar graph G1 of FIG. 8A, when the bar BR1 is not displayed, this shows that the image capture section 110 is in a parallel stereo alignment state before and after movement, and the longer the length of the bar BR1, the further away the parallelism is from parallel stereo alignment.

In the graph G2, when the center point of the spherical body represented by image GS aligns with the center of the plane represented by image GP, and the plane represented by image GP is also horizontal in the display screen DP, this means that the image capture section 110 is in parallel stereo alignment before and after movement. The graph G2 shows the rotation amount expressed by the rotation matrix R as a rotation amount of the plane represented by image GP. Namely, as shown in FIG. 8A, by the display 104 displaying the plane represented by image GP pointing towards one side in the display direction, the right hand side when facing the display direction, this means that the direction of the optical axis of the digital camera 100 is further inclined to the right hand side than the direction along the optical axis that would achieve parallel stereo alignment. According to such a configuration, display can be made of how much the digital camera 100 (the camera coordinate system of the digital camera 100) needs to be rotated to achieve a parallel stereo alignment state.

The difference in the display sideways direction between the center point of the spherical body represented by image GS and the center of the plane represented by image GP and the difference to the side in the vertical direction (vertical scanning direction side) expresses the Z component and the Y component of the translation vector t, respectively. According to this configuration, display can be made of how much the placement of the digital camera 100 facing the subject needs to be moved in the up and down direction to achieve a parallel stereo alignment state before and after movement.

After step S07 of FIG. 3 has been executed, the parallel determination section 161 of FIG. 5A determines whether or not the placement of the digital camera 100 during first image capture and the placement of the digital camera 100 at the second image capture are in parallel stereo alignment, based on whether or not the parallelism exceeds a specific threshold value (step S08).

The parallel determination section 161 determines that parallel stereo alignment has not been achieved when parallelism has exceeded a specific threshold value (step S08: No). Then, after the image capture position of the digital camera 100 has been changed again, the image acquisition section 142, the characteristic point corresponding section 143, the parallelism evaluation section 150, and the display controller 160 repeat the processing of step S04 to step S07 in sequence.

The parallel determination section 161 determines that parallel stereo alignment has been achieved when the parallelism has not exceeded the specific threshold value (step S08: Yes). Then the actual movement amount computation section 162, as shown in FIG. 6B, computes a movement amount (pixel distance) c moved of the projection point m1 to the point m2 in the image coordinate system of the point M1 on the subject accompanying the movement of the digital camera 100, and executes actual movement amount computation processing (step S09).

When actual movement amount computation processing execution has been started, the actual movement amount computation section 162 performs detection for faces of a person (subject) who is the image capture subject in the first image, and acquires characteristic points on any detected face portions (step S31). The actual movement amount computation section 162 then similarly acquires characteristic points in the second image (step S32). The actual movement amount computation section 162 then computes the pixel distance c of the two characteristic points from the difference in the coordinate values in the image coordinate system of the characteristic point in the first image and the coordinate value in the image coordinate system of the characteristic point in the second image (step S33). The actual movement amount computation section 162 then ends execution of actual movement amount computation processing.

After step S09 of FIG. 4 has been executed, the depth distance acquisition section 163 of FIG. 5A determines whether or not the image capture mode selected is a portrait mode based on signals input by user operation of the cursor key 105 and the setting key 105s. Next, the depth distance acquisition section 163 acquires a pre-stored value associated with the portrait mode of the depth distance Z from the corresponded main point C1 to the point M1 on the subject, for example, “3 meters” (step S10). Next, the depth distance acquisition section 163 acquires a value of the depth precision (depth tolerance) ΔZ associated with the portrait mode pre-stored in the flash memory 122, for example, “1 centimeter”. The depth precision ΔZ represents the allowable error in the depth distance.

Given a depth distance Z of 3 m and a depth precision ΔZ of 1 cm, the required movement amount computation section 164 then uses Equation (11) below to compute the movement amount N, required to generate 3D coordinates with a depth precision of ΔZ or better, as being “300” (step S11).

N=1/(ΔZ/Z) (11)

where Z represents the depth distance; and ΔZ represents the depth error.

Since the relative error ΔZ/Z to the depth distance Z is computed by taking a product of a multiplier and the precision determined by pixel size, the relative error ΔZ/Z is expressed by Equation (12) below. When parallel stereo alignment is achieved, since the multiplier is equivalent to the ratio of the base line length (distance from main point C1 to main point C2) to the absolute distance (absolute parallax distance), the depth Z is computed with Equation (13) and Equation (14) below. Hence, the above Equation (11) can be derived from Equation (12) to Equation (14).

ΔZ/Z=(p/B)·(Z/f) (12)

where B represents the base line length; f represents the focal point distance; and p represents the pixel size of the CMOS sensor 112 of FIG. 2. (p/B) represents the precision determined by the pixel size, and (Z/f) represents the multiplier.

Z=f·(B/d) (13)

where d represents the absolute parallax distance and is expressed by Equation (14) below.

d=p·N (14)

where N represents the movement amount of the points in image coordinates.

After step S11 of FIG. 4 has been executed, the movement amount determination section 165 of FIG. 5A determines whether or not the movement amount c that was actually moved is within a specific range so as to satisfy Equation (15) below (step S12), Equation (15) treats actual movement amounts from the required movement amount up to 20% over the required movement amount as being appropriate movement amounts (appropriate distances).

N≦ABS(c)≦N*1.2 (15)

where ABS represents the absolute value; N represents a value to satisfy Equation (11); and “*” represents multiply.

Since the absolute value of the pixel distance c is a smaller value than the absolute value of N “300”, the movement amount determination section 165 determines that c does not fall in the designated range (step S12: No). The movement amount determination section 165 accordingly determines that the movement state of the digital camera 100 has not yet moved a sufficient distance from the image capture position before movement (during first image capture) required for generating a 3D image with the specific depth precision ΔZ. This is because the depth Z cannot be determined with good precision unless there is sufficient parallax.

The required movement direction determination section 166 then determines the amount required for movement of the digital camera 100 to the right hand side, based on the determination result of the movement amount determination section 165, the fact that the sign of pixel distance c is minus, and using Table 1 below (step S13). Table 1 is stored in the flash memory 122 of FIG. 2.

TABLE 1

| | Limitations | Required Movement Direction |
|---|---|---|
| 1 | 0 < c < N | Left (−Xw axis) direction |
| 2 | 1.2 * N < c | Right (+Xw axis) direction |
| 3 | −N > c > 0 | Right (+Xw axis) direction |
| 4 | c < −1.2 * N | Left (−Xw axis) direction |

Using the coordinate value of the characteristic point in the image coordinate system of the first image as the reference, when the digital camera 100 is moved in the plus direction on the Xw axis in the world coordinate system, the sign of the pixel distance c is minus since the characteristic, point moves on the image in the minus direction of the Xw axis.

As shown in the first row of Table 1, when pixel distance c satisfies the limitations 0<c<N, the required movement direction determination section 166 determines that the digital camera 100 has moved from the image capture position of the first image in the minus direction of the Xw axis in the world coordinate system (namely, towards the left hand side when facing the subject), however sufficient distance has not been moved. The required movement direction determination section 166 therefore determines that the digital camera 100 needs to be moved further in the minus direction.

As shown in the second row of Table 1, when the pixel distance c satisfies the limitation 1.2*N<c, the required movement direction determination section 166 determines that the digital camera 100 has moved in the minus direction of the Xw axis but has moved too far in that direction. The required movement direction determination section 166 hence determines that the tire 100 needs to be moved back in the plus direction on the Xw axis.

As shown in the third row of Table 1, when the pixel distance c satisfies the limitation −N>c>0, the required movement direction determination section 166 determines that the digital camera 100 has moved in the plus direction of the Xw axis, but has not yet moved by a sufficient distance. The required movement direction determination section 166 hence determines that the digital camera 100 needs to be moved further in the plus direction.

As shown in the fourth row of Table 1, when the pixel distance c satisfies the limitation c<−1.2*N, the required movement direction determination section 166 determines that the digital camera 100 has moved in the plus direction of the Xw axis, but has moved too far in that direction. The required movement direction determination section 166 hence determines that the digital camera 100 needs to be moved back in the minus direction of the Xw axis.

After step S13 of FIG. 4 has been executed, the display controller 160 controls the display 104 of FIG. 1B based on the determination result of the required movement direction determination section 166, such that an arrow image GA, like that shown in FIG. 8B urging the digital camera 100 to be moved to the right hand side, is displayed on the display screen DP (step S14). According to such a configuration, display can be made of which direction the digital camera 100 should be moved, to the right hand side or the left hand side relative to the subject, in order to be able to generate a 3D image with the specific precision. According to such a configuration, there is no requirement to use a fixed base line length, the base line length can be changed according to the distance to the subject, and display can be made when the digital camera 100 has been moved by the changed base line length.

The display controller 160 of FIG. 5A controls the display 104 based on the determination result of the movement amount determination section 165 so as to display a bar graph G3 with the movement distance required shown by a bar BR3 as in FIG. 8B. According to such a configuration, a user can be readily informed of the amount by which the digital camera 100 should be moved.

After the digital camera 100 has been moved further in the right direction by a user under the instruction from the arrow image GA, the processing of step S04 to step S11 of FIG. 3 is executed again in sequence by the image acquisition section 142, the characteristic point corresponding section 143, the parallelism evaluation section 150, the display controller 160, the parallel determination section 161, the actual movement amount computation section 162, the depth distance acquisition section 163, and the required movement amount computation section 164. The image acquisition section 142 discards the second image acquired the previous time in order to re-acquire a second image.

After the processing of step S11 has been executed, since the absolute value of the pixel distance c re-computed at step S11 is now a greater value than the value “360” of 1.2*N, the movement amount determination section 165 determines that c does not fall into the determined range to satisfy above Equation (12) (step S12: No). The movement amount determination section 165 then determines that since the pixel distance c is larger than the value of 1.2*N, the movement state of the digital camera 100 is too far separated from the image capture position of the first image for generating a 3D image with the specific depth precision ΔZ. This is because even if there is the same location on a subject, since the view points are too different from each other, parallax is too great, and so way in which this location is represented on the first image and the second image are too different from each other. In such cases, for the same point on the subject, the point represented on the first image cannot be corresponded to the point on the second image with good precision, and hence the depth Z cannot be determined with good precision.

The required movement direction determination section 166 then determines the amount of movement required of the image capture position of the digital camera 100 back to the left hand side, based on the determination result of the movement amount determination section 165 and the fact that the sign of pixel distance c is minus, using the fourth row of Table 1 above (step S13).

The display controller 160 then, based on the determination result of the movement amount determination section 165, displays on the display 104 an image to urge the digital camera 100 to be moved back to the left (step S14).

After the digital camera 100 has been moved towards the left by a user, the processing of step S04 to step S11 of FIG. 3 are executed again.

After the processing of step Sit has been executed, the movement amount determination section 165 determines that the pixel distance c re-computed at step S11 is now in the designated range (step S12: Yes). The notification control section 167 then controls the speaker 129 of FIG. 2 to inform a user by an alarm that the digital camera 100 is in an appropriate position to generate a 3D image with the specific depth precision ΔZ (step S15).

Next, as shown in FIG. 6C, the 3D image generator 170 of FIG. 5A executes 3D modeling processing to generate a 3D image of the subject using the first image and the second image (step S16). Note that configuration may be made such that, after waiting for the shutter button 109 of FIG. 1A to be depressed, the 3D image generator 170 executes 3D modeling processing using the first image and the newly captured image.

AT the start of 3D modeling processing, the 3D image generator 170 employs a Harris corner detection method to give characteristic point candidates of isolated points of density gradient in the first image and isolated points of density gradient in the second image (step S14). The 3D image generator 170 acquires plural individual characteristic point candidates.

The 3D image generator 170 then uses template matching with Sum of Squared Difference (SSD) to determine that those characteristic point candidates of the first image and those characteristic point candidates of the second image that have a degree of correlation R_SSD of a specific threshold value or less as being characteristic points of the first image and characteristic points of the second image (step S42). The degree of correlation R_SSD is computed using Equation (16) below. The 3D image generator 170 determines correspondences of plural individual characteristic points.

R_SSD=ΣΣ(K−T)² (16)

where: K represents the subject image (namely a template of a region up to a specific distance from the characteristic point candidate in the first image); T represents a reference image (namely a region in the second image the same shape as K); and ΣΣ represents the sum of pixels in the horizontal direction and the vertical direction.

When step S42 is executed, the 3D image generator 170 computes position data expressing the position (u1, v1) in the image coordinates of the characteristic point of the first image, and position data expressing the position (u′1, v′1) in the image coordinates of the characteristic point of the second image (step S43). The 3D image generator 170 uses this position data to generate a 3D image (namely a polygon) expressed by Delaunay triangulation (step S44).

Specifically, the 3D image generator 170 generates a 3D image complying with the following 2 conditions. The first condition is that the 3D image generator 170 generates a 3D image of the subject of relative size without data relating to scale. This first condition means that the placements of the image capture section 110 during first image capture and during second image capture are in parallel stereo alignment. Under the second condition, the position of the characteristic point in the first image (u1, v1) is corresponded to the position of the characteristic point in the second image (u′1, v′1), and the following Equation (17) to Equation (19) are satisfied when the corresponded points are regenerated at the position (X1, Y1, Z1) expressed in 3D coordinates.

X1=u1/(u1−u′1) (17)

Y1=v1/(u1−u′1) (18)

Z1=f/(u1−u′1) (19)

Using the above Equation (17) to Equation (19) the 3D image generator 170 computes the positions expressed in 3D coordinates for the characteristic points of the remaining corresponded characteristic points, and generates a 3D image of a polygon with apexes at the points of the derived positions. The 3D image generator 170 then ends execution of the 3D modeling processing.

According to this configuration, when the placements of the image capture section 110 during first image capture and during second image capture are in parallel stereo alignment, the above Equation (17) to Equation (19) are used to generate a 3D image expressing the subject, and a 3D image can be generated with less computational load than when generating a 3D image using the Equation (20) when the placements are not in parallel stereo alignment.

trans(u1,v1,1)˜P·trans(X1,Y1,Z1,1)

trans(u′1,v′1,1)˜P′·trans(X1,Y1,Z1,1) (20)

where “˜” represents equivalence allowing for a constant multiple between two terms; matrix P represents a projection matrix onto the camera coordinate system of the first image (camera projection parameter); and matrix P′ represents a camera projection parameter of the second image.

After step S16 of FIG. 4 has been executed, the display controller 160 of FIG. 5A controls the display 104 of FIG. 1B so as to display a 3D image of the subject (step S17). The output controller 171 then controls the USB controller 128 of FIG. 2 so as to output an electronic file expressing the 3D image to a computer connected to the USB terminal connector 107 of FIG. 1C (step S18). The 3D image saving section 172 then saves the 3D image in the flash memory 122 of FIG. 2 (step S19). The digital camera 100 then ends execution of 3D image generation processing.

Explanation has been given of cases in the present exemplary embodiment in which the actual movement amount computation section 162 acquires a characteristic point from an image portion in which a face is represented of a person (subject) for image capture. However, configuration may be made such that the actual movement amount computation section 162 acquires a characteristic point from an image region where the focal point was aligned (namely, an image region at a specific distance from the central portion of the image). According to such a configuration, since the subject is more sharply represented at the image region aligned with the focal point compared with other regions, the characteristic points can be corresponded with good precision. The digital camera 100 may be provided with a touch panel on the display 104 of FIG. 1B, and the characteristic points may be acquired from image regions designation by user operation of the touch panel.

The functionality according to embodiments described herein can be achieved by a digital camera provided in advance with the configuration for realizing these functions, and can be achieved by making an existing digital camera function as a digital camera according to embodiments described herein by application of a program. Namely, an existing digital camera can be made to function as the digital camera 100 according to embodiments described herein by application of a control program, for realizing configuration of each of the functions of the digital camera 100 described in the above exemplary embodiment, such that execution can be performed in a computer (CPU) for controlling an existing digital camera.

Any appropriate distribution method may be employed for such a program, for example, distribution can be made stored on a storage medium such as a memory card, CD-ROM or DVD-ROM, and distribution can also be made via a communications medium such as the Internet.

While the present invention has been shown and described with reference to certain exemplary embodiments thereof will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. An image capture apparatus comprising:
an image capture section configured to capture an image of a subject;
a focal point distance detector configured to detect a focal point distance from a main point of the image capture section to a focal point of the image capture section on the subject;
an image acquisition section configured to acquire first and second images of the subject, the first and second images being captured by the image capture section whose focal point is on the subject;
an image position detector configured to detect a first image position and a second image position, wherein the first image position represents a position of a certain point on the subject in the first image, and the second image position represents a position of the certain point on the subject in the second image;
a 3D image generator configured to generate a 3D image of the subject based on a difference between the first image position and the second image position;
a parallelism computation section configured to compute parallelism based on the first and second image positions and the focal point distance, the parallelism representing a degree to which an optical axis of the image capture section during capture of the first image and an optical axis of the image capture section during capture of the second image capture are parallel to each other; and
a display section configured to display the parallelism.

2. The apparatus of claim 1, wherein the parallelism further represents a degree to which a first vertical scanning direction of the first image projected onto a projection plane of the image capture section and a second vertical scanning direction of the second image projected onto the projection plane of the image capture section are parallel to each other.

3. The apparatus of claim 2, wherein the parallelism further represents a degree to which a first horizontal scanning direction of the first image projected onto the projection plane and a second horizontal scanning direction of the second image projected onto the projection plane are parallel to each other.

4. The apparatus of claim 3, wherein the parallelism further represents a degree to which a movement direction of the main point of the image capture section between during the capture of the first image and the capture of the second image is different from the vertical scanning direction or the horizontal scanning direction.

5. The apparatus of claim 1, further comprising:
a depth distance acquisition section configured to acquire a depth distance from the main point to the subject;
an actual movement amount computation section configured to compute an actual movement amount of the certain point between the first image and the second image, based on the first and second image positions;
a movement amount computation section configured to compute a movement amount to generate the 3D image, based on the depth distance;
a movement direction computation section configured to compute a movement direction of the image capture section based on the actual movement amount and the movement amount to generate the 3D image,
wherein the 3D image generator is configured to generate the 3D image with a certain depth accuracy, based on the movement amount and the movement direction, and
wherein the display section is configured to display the movement direction.

6. The apparatus of claim 4, further comprising:
a parallelism determination section configured to determine, based on the parallelism, whether or not the image capture section during the capture of the first image and the image capture section during the capture of the second image are aligned in parallel stereo,
wherein the 3D image generator is configured to generate the 3D image when the parallelism determination section determines that the image capture section during the capture of the first image and the image capture section during the capture of the second image are aligned in parallel stereo.

7. A computer-readable medium storing a program for causing the computer to perform operations comprising:
(a) capturing an image of a subject by an image capture section;
(b) detecting a focal point distance from a main point of the image capture section to a focal point of the image capture section on the subject;
(c) acquiring first and second images of the subject, the first and second images being captured by the image capture section whose focal point is on the subject;
(d) detecting a first image position and a second image position, wherein the first image position represents a position of a certain point on the subject in the first image, and the second image position represents a position of the certain point on the subject in the second image;
(e) generating a 3D image of the subject based on a difference between the first image position and the second image position;
(f) computing parallelism based on the first and second image positions and the focal point distance, the parallelism representing a degree to which an optical axis of the image capture section during capture of the first image and an optical axis of the image capture section during capture of the second image capture are parallel to each other; and
(g) displaying the parallelism.

8. An image capture method, comprising:
(a) capturing an image of a subject by an image capture section;
(b) detecting a focal point distance from a main point of the image capture section to a focal point of the image capture section on the subject;
(c) acquiring first and second images of the subject, the first and second images being captured by the image capture section whose focal point is on the subject;
(d) detecting a first image position and a second image position, wherein the first image position represents a position of a certain point on the subject in the first image, and the second image position represents a position of the certain point on the subject in the second image;
(e) generating a 3D image of the subject based on a difference between the first image position and the second image position;
(f) computing parallelism based on the first and second image positions and the focal point distance, the parallelism representing a degree to which an optical axis of the image capture section during capture of the first image and an optical axis of the image capture section during capture of the second image capture are parallel to each other; and
(g) displaying the parallelism.
